(19) United States
(12) Patent Application Publication
(10) Pub. No.: US 2025/0357748 A1
(43) Pub. Date: Nov. 20, 2025

(54) METHOD FOR ADJUSTING SHORT-CIRCUIT PROTECTION VALUE, POWER TOOL, AND COMPUTER-READABLE MEDIUM

(71) Applicant: JIANGSU DONGCHENG TOOLS TECHNOLOGY CO., LTD, Nantong (CN)

(72) Inventors: Chunlei LU, Nantong (CN); Ruifeng LU, Nantong (CN)

(21) Appl. No.: 18/869,441

(22) PCT Filed: Jan. 24, 2024
(86) PCT No.: PCT/CN2024/073828

§ 371 Date: Nov. 26, 2024

(30) Foreign Application Priority Data
Feb. 7, 2023 (CN) 202310079355.3

(51) Int. Cl. H02H 5/04; H02H 1/00; H02H 3/08; H02H 7/085

(52) U.S. Cl. CPC H02H 5/042; H02H 1/0007; H02H 1/0092; H02H 3/08; H02H 5/047; H02H 7/085

(57) ABSTRACT

The present application relates to a method for adjusting a short-circuit protection value, a power tool, and a computer-readable medium. The method for adjusting a short-circuit protection value comprises the following steps: acquiring a voltage value of an NTC resistor by a sampling module; calculating a temperature value of an MOS tube according to the acquired voltage value of the NTC resistor by an MCU; determining a temperature interval in which the temperature value of the MOS tube is located by the MCU; and calculating a corresponding short-circuit protection value according to the temperature interval by the MCU, the short-circuit protection value being in a linear relationship with the temperature interval, and the short-circuit protection value decreasing as the temperature interval increases.

### FIELD

The present application relates to the field of power tools, and in particular to a method for adjusting a short-circuit protection value, a power tool and a computer-readable medium.

### BACKGROUND

Traditional power tools generally have a short-circuit protection function, when the current of the power tool is large, the MOS tube can be turned off in time to protect the MOS tube and the circuit. However, after the power tool has been running for a period of time, the temperature of the MOS tube will rise, and according to the MOS characteristic curve, higher the temperature of the MOS tube, smaller the current value the MOS tube can withstand. Furthermore, in the event of blocking of the power tool, the blocking current value is typically seven times the rated current value.

Therefore, if the power tool has been running for a period of time, and when the MOS tube is at a high temperature and can withstand a lower current, the tool is blocked at this time, the blocking current value increases, the short-circuit protection value is not adjusted accordingly which may result in burnt out of the MOS tube, even damaging the circuit.

Therefore, it is necessary to design a method to adjust the short-circuit protection value to solve the above problems.

### SUMMARY

In view of the shortcomings of the prior art, the present application aims to provide a method for adjusting short-circuit protection value to solve the problem that the temperature of the MOS tube rises, the current it withstands is small, and under blocking occurs when the MOS tube is in a high-temperature state, the MOS tube is damaged.

The present application may solve the existing technical problem by adopting the following technical solution: a method for adjusting a short-circuit protection value includes the following steps:
acquiring a voltage value of an NTC resistor by a sampling module;
calculating a temperature value of an MOS tube according to the voltage value of the NTC resistor by an MCU;
determining a temperature interval within which the temperature value of the MOS tube falls; and
calculating a corresponding short-circuit protection value according to the temperature interval by the MCU, wherein the short-circuit protection value is linearly related to the temperature interval, and the short-circuit protection value decreases as the temperature interval increases.

A further improvement is that: a relationship between the short-circuit protection value and the temperature interval is: [symbol] =180−20 [symbol] , [symbol] is the short-circuit protection value, [symbol] is the temperature interval.

A further improvement is that: the temperature interval is divided as follows: under the temperature value is between a first threshold and a second threshold, the temperature interval is divided according to a first granularity.

A further improvement is that: the first threshold is 50° C., the second threshold is 110° C., and the first granularity is 20° C.; a relationship between the temperature value and the temperature interval is as follows: under the temperature value is below the first threshold, the temperature interval is interval 0; under the temperature value is between the first threshold and the second threshold, the temperature interval is divided into intervals 1, 2, and 3, according to the first granularity. A further improvement is that: when the temperature value is higher than the second threshold, the MCU activates temperature protection function.

A further improvement is that: a power tool includes an NTC resistor, a sampling module, and an MCU; the sampling module is electrically connected to the MCU, and the sampling module is configured to acquire a voltage value of the NTC resistor, and transmit the voltage value of the NTC resistor to the MCU; the MCU is configured to receive the voltage value of the NTC resistor transmitted by the sampling module, and calculate a temperature value of an MOS tube according to the voltage value of the NTC resistor, determine a temperature interval in which the temperature value of the MOS tube is located, and calculate a short-circuit protection value according to the temperature interval; wherein, the short-circuit protection value is linearly related to the temperature interval, and the short-circuit protection value decreases as the temperature interval increases.

A further improvement is that: a relationship between the short-circuit protection value and the temperature interval is: [symbol] =180−20 [symbol] , [symbol] is the short-circuit protection value, [symbol] is the temperature interval.

A further improvement is that: the temperature interval is divided as follows: under the temperature value is between a first threshold and a second threshold, the temperature value is divided according to a first granularity.

A further improvement is that: the first threshold is 50° C., the second threshold is 110° C., and the first granularity is 20° C.; a relationship between the temperature value and the temperature interval is as follows: under the temperature value is below the first threshold, the temperature interval is interval 0; under the temperature value is between the first threshold and the second threshold, the temperature interval is divided into intervals 1, 2, and 3, according to the first granularity. A further improvement is that: when the temperature value is higher than the second threshold, the MCU activates temperature protection function.

A further improvement is that: a power tool includes a memory and a processor, computer program is stored in the storage and runnable on the processor, when the processor executes the computer program, the power tool is enabled to implement the method: acquiring a voltage value of a negative temperature coefficient (NTC) resistor by a sampling module; calculating a temperature value of an MOS tube according to the voltage values of the NTC resistor by an MCU; determining a temperature interval in which the temperature value of the MOS tube is located by the MCU; and calculating a corresponding short-circuit protection value according to the temperature interval by the MCU, wherein the short-circuit protection value is linearly related to the temperature interval, and the short-circuit protection value decreases as the temperature interval increases. A further improvement is that: a relationship between the short-circuit protection value and the temperature interval is: [symbol] =180−20 [symbol] , [symbol] is the short-circuit protection value, [symbol] is the temperature interval. A further improvement is that: the temperature interval is divided as follows: under the temperature value is between a first threshold and a second threshold, the temperature interval is divided according to a first granularity. A further improvement is that: the first threshold is 50° C., the second threshold is 110° C., and the first granularity is 20° C.; a relationship between the temperature value and the temperature interval is as follows: under the temperature value is below the first threshold, the temperature interval is interval 0; under the temperature value is between the first threshold and the second threshold, the temperature interval is divided into intervals 1, 2, and 3, according to the first granularity. A further improvement is that: the temperature value is higher than the second threshold, the MCU activates temperature protection function.

A further improvement is that: a computer-readable medium having non-volatile program code executable by a processor, the program code is executed by the processor and configured to implement the method. A further improvement is that: a relationship between the short-circuit protection value and the temperature interval is: [symbol] =180−20 [symbol] , [symbol] is the short-circuit protection value, [symbol] is the temperature interval. A further improvement is that: the temperature interval is divided as follows: under the temperature value is between a first threshold and a second threshold, the temperature interval is divided according to a first granularity. A further improvement is that: the first threshold is 50° C., the second threshold is 110° C., and the first granularity is 20° C.; a relationship between the temperature value and the temperature interval is as follows: under the temperature value is below the first threshold, the temperature interval is interval 0; under the temperature value is between the first threshold and the second threshold, the temperature interval is divided into intervals 1, 2, and 3, according to the first granularity. A further improvement is that: the temperature value is higher than the second threshold, the MCU activates temperature protection function.

Compared with the prior art, the present application has the following beneficial effects: the present application utilizes the NTC resistor to calculate the temperature value of the MOS tube, which is not only high in detection accuracy but also fast and convenient, and secondly, adopts the method of setting the short-circuit protection value in a stepwise manner with the temperature, which can protect the MOS more effectively, in the event that the MOS tube is in a high temperature state and withstands a small current value, it can effectively protect the MOS from being burned out.

### BRIEF DESCRIPTION OF THE DRAWINGS

The specific embodiments of the present application are described in further detail below in conjunction with the accompanying drawings:

FIG. 1 is a schematic diagram of an embodiment of the present application.

FIG. 2 shows a graph of MOS withstanding current vs. temperature of an embodiment of the present application.

FIG. 3 is a flowchart of an embodiment of the present application.

### DETAILED DESCRIPTION

The present application is described in further detail below in conjunction with the accompanying drawings and embodiments.

The method for adjusting the short-circuit protection value described in the present application is applicable to intelligent device such as power tool/power device, the power tool/power device may be gardening tool, scissors tool, or other traditional power tools with short-circuit protection functions; as long as the above-mentioned device/tools can adopt the essential content of the technical solution disclosed below, they can fall within the protection scope of the present application.

As the traditional motor drive circuit generally use MOS as a switching tube, the motor work for a period of time will cause the MOS high temperature condition, and MOS can withstand the current value will be reduced with the increase in the temperature of the MOS tube, which will lead to the motor running for a period of time, under the motor blocking, blocking the current increases, it will burn out the MOS, damage to the circuit, affecting the normal use of the tool.

Therefore, in order to solve the above problem and prolong the service life of the tool, the present application provides a method of adjusting the short-circuit protection value, the method utilizes the NTC resistor to calculate the temperature value of the MOS tube, which is not only high in detection accuracy but also fast and convenient, and secondly, adopts the method of setting the short-circuit protection value in a stepwise manner with the temperature, which can protect the MOS more effectively, in the event that the MOS tube is in a high temperature state and withstands a small current value, it can effectively protect the MOS from being burned out.

The working principle of the present application is described in detail below in accordance with the accompanying drawings and embodiments.

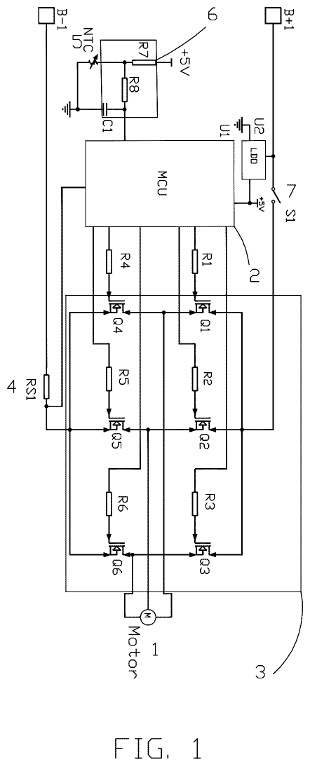

Referring to FIG. 1, FIG. 1 is a schematic diagram of an embodiment of the present application. In the figure, LDO is a regulated power supply to provide 5V voltage to a microcontroller unit (MCU); MOS tubes Q1, Q2, Q3, Q4, Q5, Q6 constitute a drive module to control the operation of a brushless motor; R7, R8, and C1 constitute a sampling module to collect the voltage value of the NTC resistor and transmit the voltage value to the MCU; RS1 constitutes a detection module to detect the running current value of the motor; S1 constitutes a switch module to control the system power-on and motor operation; MCU is used to receive the voltage value of the NTC resistor collected by the sampling module, calculate a temperature value of the MOS tube, and determine the temperature interval into which the temperature value falls, and calculate a short-circuit protection value according to the temperature interval. Due to the NTC resistor has the characteristic that the resistance value changes with temperature, the NTC resistor is attached to the vicinity of the MOS tube to sense the temperature of the MOS, the temperature increase of MOS corresponds to a decrease in the resistance of NTC resistor, and the voltage also decreases accordingly. Preferably, the sampling module acquires the voltage value of the NTC resistor, and the sampling module can be a voltage divider circuit, or an independent module with an acquisition function, or a module with an acquisition function located in the MCU, and then the MCU calculates the temperature value of the MOS tube based on the corresponding relationship between a pre-stored temperature value of the MOS and the voltage value of the NTC resistor.

In a preferred embodiment, the voltage value of the NTC resistor may also be calculated by collecting the resistance value of the NTC resistor by an MCU or a calculation detection module with a calculation detection function, the corresponding relationship between the resistance value of the NTC resistor and the voltage value is: voltage value=(5+resistance value of the NTC resistor)÷(resistance value of the NTC resistor+resistance value of the R_{T}).

The corresponding relationship between the temperature value and the voltage value of the NTC resistor is as follows:

| | | | | |
|---|---|---|---|---|
| Voltage value | U ≥ 1.45 V | 0.9 V ≥ | 0.55 V ≥ | 0.34 V ≥ |
| U of the NTC | | U > 1.45 V | U > 0.9 V | U > 0.55 V |
| resistor | | | | |
| Temperature ϑ | ϑ < 50 | 50 ≤ ϑ < 70 | 70 ≤ ϑ < 90 | 90 ≤ ϑ ≤ 110 |

Then the MCU determines the temperature interval into which the temperature of the MOS falls that the temperature of the MOS falls into, according to the relationship between the short-circuit protection value and the temperature range, [symbol] =180−20 [symbol] , [symbol] is the short-circuit protection value, [symbol] is the temperature interval, and the corresponding short-circuit protection value is calculated. This method of setting the short-circuit protection value stepwise with temperature can protect the MOS more effectively, and effectively protect the MOS from being burned when the MOS withstands the current poorly at high temperature. The short-circuit protection value is specifically a current threshold for triggering short-circuit protection, i.e., when the current reaches the current threshold, the circuit will trigger short-circuit protection.

The temperature interval division standard is: under the temperature value is between the first threshold and the second threshold, according to the first granularity division. The first threshold is 50° C., the second threshold is 110° C., and the first granularity is 20° C. The relationship between the temperature value and the temperature interval is as follows: the temperature value below the first threshold is interval 0, and the temperature value between the first threshold and the second threshold is divided into intervals 1 to 3 according to the first granularity. When the temperature is higher than the second threshold, the MCU directly activates the temperature protection function.

The corresponding relationship between the temperature value and the temperature interval is as follows:

| | | | | | |
|---|---|---|---|---|---|
| Temperature | ϑ < 50 | 50 << | 70 << | 90 << | 110 < ϑ |
| ϑ | | ϑ < 70 | ϑ < 90 | ϑ << 110 | |
| Temperature | 0 | 1 | 2 | 3 | Temperature |
| interval | | | | | protection |

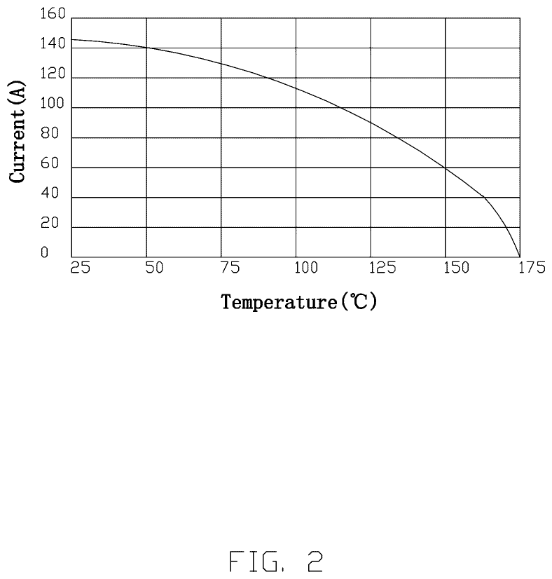

Referring to FIG. 2, FIG. 2 shows a graph of the MOS withstanding current and temperature of a preferred embodiment of the present application. From the figure, it can be seen that the maximum current value that the MOS tube can withstand decreases as the temperature of the MOS tube increases, the higher the temperature of the MOS tube, the smaller the maximum current value it can withstand, and the lower the temperature of the MOS tube, the larger the maximum current value it can withstand.

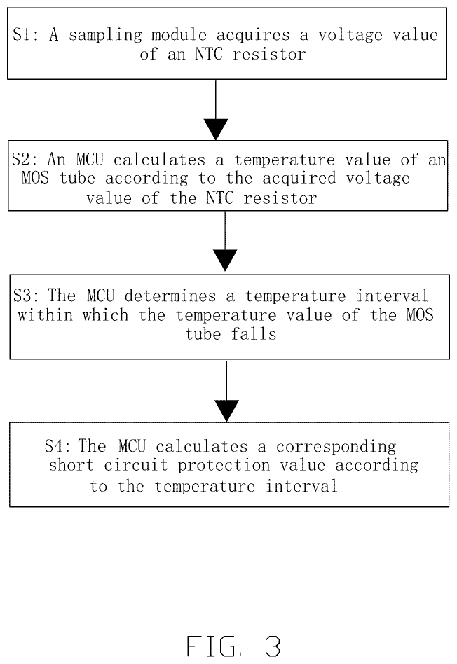

Referring to FIG. 3, FIG. 3 is a flow chart of a preferred embodiment of the present application.

A sampling module acquires a voltage value of an NTC resistor.

An MCU calculates a temperature value of an MOS tube according to the acquired voltage value of the NTC resistor.

The MCU determines a temperature interval within which the temperature value of the MOS tube falls.

The MCU calculates a corresponding short-circuit protection value according to the temperature interval.

The sampling module may be a voltage divider circuit, or an independent module with an acquisition function, or a module with an acquisition function located in the MCU, the short-circuit protection value is linearly related to the temperature interval within an interval, and the short-circuit protection value decreases as the temperature interval increases. The NTC resistor has the characteristic that the resistance changes with temperature, so the NTC resistor is attached near the MOS tube to sense the temperature of the MOS. When the temperature of the MOS tube increases, the resistance of the NTC resistor decreases, and the voltage also decreases accordingly.

In a preferred embodiment, the voltage value of the NTC resistor may also be calculated by collecting the resistance value of the NTC resistor by an MCU or a calculation detection module with a calculation detection function, the corresponding relationship between the resistance value of the NTC resistor and the voltage value is: voltage value=(5+resistance value of the NTC resistor)÷(resistance value of the NTC resistor+resistance value of the RT).

The corresponding relationship between the temperature value and the voltage value of the NTC is as follows:

| | | | | |
|---|---|---|---|---|
| Voltage value | U ≥ 1.45 V | 0.9 V ≥ | 0.55V ≥ | 0.34 V ≥ |
| U of the NTC | | U > 1.45 V | U > 0.9 V | U > 0.55 V |
| resistor | | | | |
| Temperature ϑ | ϑ < 50 | 50 ≤ ϑ < 70 | 70 ≤ ϑ < 90 | 90 ≤ ϑ ≤ 110 |

The temperature interval division standard is: under the temperature value is between the first threshold and the second threshold, according to the first granularity division. The first threshold is 50° C., the second threshold is 110° C., and the first granularity is 20° C. The relationship between the temperature value and the temperature interval is as follows: the temperature value below the first threshold is interval 0, and the temperature value between the first threshold and the second threshold is divided into intervals 1 to 3 according to the first granularity. When the temperature is higher than the second threshold, the MCU directly determines temperature protection.

The corresponding relationship between the temperature value and the temperature interval is as follows:

| | | | | | |
|---|---|---|---|---|---|
| Temperature | ϑ < 50 | 50 << | 70 << | 90 << | 110 < ϑ |
| ϑ | | ϑ < 70 | ϑ < 90 | ϑ << 110 | |
| Temperature | 0 | 1 | 2 | 3 | Temperature |
| interval | | | | | protection |

The relationship between the short-circuit protection value and the temperature interval is: [symbol] =180−20 [symbol] , [symbol] is the short-circuit protection value and [symbol] is the temperature interval.

This method of setting the short-circuit protection value stepwise with temperature can protect the MOS more effectively, and effectively protect the MOS from being burned when the MOS withstands the current poorly at high temperature. The short-circuit protection value is specifically a current threshold for triggering short-circuit protection, i.e., when the current reaches the current threshold, the circuit will trigger short-circuit protection.

The present application utilizes the NTC resistor to calculate the temperature value of MOS tubes, which is not only high in detection accuracy but also fast and convenient, and secondly, adopts the method of setting the short-circuit protection value in a stepwise manner with the temperature, which can protect the MOS more effectively, in the MOS high temperature to withstand the current is poor, effectively protect the MOS is not burned. In addition, this method can effectively overcome the situation that the circuit is damaged when the MOS tube is blocked at high temperature, thereby extending the service life of the tool.

The present application also provides a power tool, the power tool includes a memory, a processor, the memory stores a computer program that can be run on the processor, and the processor is used to implement the method for adjusting the short-circuit protection value when executing the computer program.

The present application also provides a computer-readable medium having a non-volatile program code executable by a processor, the program code enables the processor to execute the method for adjusting the short-circuit protection value.

Those skilled in the art can clearly understand that, for the convenience and brevity of description, the specific working process of the power tool described above can refer to the corresponding process in the aforementioned method implementation column and will not be repeated here.

If the functions are implemented in the form of software functional units and sold or used as independent products, they can be stored in a computer-readable storage medium. Based on this understanding, the technical solution of the present application, or the part that contributes to the prior art, or the part of the technical solution, can be embodied in the form of a software product. The computer software product is stored in a storage medium, including several instructions for a computer device (which can be a personal computer, server, or network device, etc.) to perform all or part of the steps of the methods described in each embodiment of the present application. The aforementioned storage medium include: U disk, mobile hard disk, Read-Only Memory (ROM), random access memory (RAM), disk or optical disk, and other medium that can store program codes.

Finally, it should be noted that the above-described embodiments are only specific implementation methods of the present application, which are used to illustrate the technical solutions of the present application rather than to limit them. The protection scope of the present application is not limited thereto. Although the present application has been described in detail with reference to the aforementioned embodiments, those of ordinary skill in the art should understand that any technician familiar with the technical field can still modify the technical solutions recorded in the aforementioned embodiments within the technical scope disclosed by the present application, or make equivalent replacements for some of the technical features therein; and these modifications, changes or replacements do not deviate the essence of the corresponding technical solutions from the spirit and scope of the technical solutions of the embodiments of the present application, and should all be covered within the protection scope of the present application. Therefore, the protection scope of the present application should be based on the protection scope of the claims.

1. A method for adjusting a short-circuit protection value, wherein the method for adjusting the short-circuit protection value comprises:
acquiring a voltage value of a negative temperature coefficient (NTC) resistor by a sampling module;
calculating a temperature value of an MOS tube according to the voltage values of the NTC resistor by an MCU;
determining a temperature interval within which the temperature value of the MOS tube falls in which the temperature value of the MOS tube is located by the MCU; and
calculating a corresponding short-circuit protection value according to the temperature interval by the MCU, wherein the short-circuit protection value is linearly related to the temperature interval, and the short-circuit protection value decreases as the temperature interval increases.

2. The method for adjusting the short-circuit protection value according to claim 1, wherein: a relationship between the short-circuit protection value and the temperature interval is: [symbol] =180−20 [symbol] , [symbol] is the short-circuit protection value, [symbol] is the temperature interval.

3. The method for adjusting the short-circuit protection value according to claim 1, characterized in that: the temperature interval is divided as follows: under the temperature value is between a first threshold and a second threshold, the temperature interval is divided according to a first granularity.

4. The method for adjusting the short-circuit protection value according to claim 3, wherein: the first threshold is 50° C., the second threshold is 110° C., and the first granularity is 20° C.; a relationship between the temperature value and the temperature interval is as follows: under the temperature value is below the first threshold, the temperature interval is interval 0; under the temperature value is between the first threshold and the second threshold, the temperature interval is divided into intervals 1, 2, and 3, according to the first granularity.

5. The method for adjusting the short-circuit protection value according to claim 4, wherein: when the temperature value is higher than the second threshold, the MCU activates temperature protection function.

6. A power tool comprising a negative temperature coefficient (NTC) resistor, a sampling module, and an MCU, wherein:
the sampling module is electrically connected to the MCU, and the sampling module is configured to acquire a voltage value of the NTC resistor, and transmit the voltage value of the NTC resistor to the MCU;
the MCU is configured to receive the voltage value of the NTC resistor transmitted by the sampling module, and calculate a temperature value of an MOS tube according to the voltage value of the NTC resistor, determine a temperature interval in which the temperature value of the MOS tube is located, and calculate a short-circuit protection value according to the temperature interval;
wherein, the short-circuit protection value is linearly related to the temperature interval, and the short-circuit protection value decreases as the temperature interval increases.

7. The power tool according to claim 6, wherein: a relationship between the short-circuit protection value and the temperature interval is: [symbol] =180−20 [symbol] , [symbol] is the short-circuit protection value, [symbol] is the temperature interval.

8. The power tool according to claim 6, wherein: the temperature interval is divided as follows: under the temperature value is between a first threshold and a second threshold, the temperature value is divided according to a first granularity.

9. The power tool according to claim 8, wherein: the first threshold is 50° C., the second threshold is 110° C., and the first granularity is 20° C.; a relationship between the temperature value and the temperature interval is as follows: under the temperature value is below the first threshold, the temperature interval is interval 0; under the temperature value is between the first threshold and the second threshold, the temperature interval is divided into intervals 1, 2, and 3, according to the first granularity.

10. The power tool according to claim 9, wherein: when the temperature value is higher than the second threshold, the MCU activates temperature protection function.

11. A power tool comprising a memory and a processor, computer program is stored in the storage and runnable on the processor, wherein,
when the processor executes the computer program, the power tool is enabled to implement the method:
acquiring a voltage value of a negative temperature coefficient (NTC) resistor by a sampling module;
calculating a temperature value of an MOS tube according to the voltage values of the NTC resistor by an MCU;
determining a temperature interval in which the temperature value of the MOS tube is located by the MCU; and
calculating a corresponding short-circuit protection value according to the temperature interval by the MCU, wherein the short-circuit protection value is linearly related to the temperature interval, and the short-circuit protection value decreases as the temperature interval increases.

12. The power tool according to claim 11, wherein: a relationship between the short-circuit protection value and the temperature interval is: [symbol] =180−20 [symbol] , [symbol] is the short-circuit protection value, [symbol] is the temperature interval.

13. The power tool according to claim 11, characterized in that: the temperature interval is divided as follows: under the temperature value is between a first threshold and a second threshold, the temperature interval is divided according to a first granularity.

14. The power tool according to claim 13, wherein: the first threshold is 50° C., the second threshold is 110° C., and the first granularity is 20° C.; a relationship between the temperature value and the temperature interval is as follows: under the temperature value is below the first threshold, the temperature interval is interval 0; under the temperature value is between the first threshold and the second threshold, the temperature interval is divided into intervals 1, 2, and 3, according to the first granularity.

15. The power tool according to claim 14, wherein: when the temperature value is higher than the second threshold, the MCU activates temperature protection function.

16. A computer-readable medium having non-volatile program code executable by a processor, wherein, the program code is executed by the processor and configured to implement the method according to claim 1.

17. The computer-readable medium according to claim 16, wherein: a relationship between the short-circuit protection value and the temperature interval is: [symbol] =180−20 [symbol] , [symbol] is the short-circuit protection value, [symbol] is the temperature interval.

18. The computer-readable medium according to claim 16, characterized in that: the temperature interval is divided as follows: under the temperature value is between a first threshold and a second threshold, the temperature interval is divided according to a first granularity.

19. The computer-readable medium according to claim 18, wherein: the first threshold is 50° C., the second threshold is 110° C., and the first granularity is 20° C.; a relationship between the temperature value and the temperature interval is as follows: under the temperature value is below the first threshold, the temperature interval is interval 0; under the temperature value is between the first threshold and the second threshold, the temperature interval is divided into intervals 1, 2, and 3, according to the first granularity.

20. The computer-readable medium according to claim 19, wherein: when the temperature value is higher than the second threshold, the MCU activates temperature protection function.
